(19) United States
(12) Patent Application Publication
(10) Pub. No.: US 2009/0298345 A1
(43) Pub. Date: Dec. 3, 2009

(54) CONNECTOR

(76) Inventors: Takeki Fukazawa, Tokyo (JP); Takanobu Yoshimi, Tokyo (JP); Masato Hida, Tokyo (JP)

Correspondence Address: DICKSTEIN SHAPIRO LLP, 1825 EYE STREET NW, Washington, DC, 20006-5403, US

(21) Appl. No.: 12/469,822

(22) Filed: May 21, 2009

(30) Foreign Application Priority Data
May 30, 2008 (JP) 2008-141808

(51) Int. Cl. H01R 27/02

(52) U.S. Cl. 439/638

(57) ABSTRACT

A connector includes a plurality of contacts each having a contact portion adapted to contact a first connecting object, a fixed portion to be fixed to a housing, a connection portion to be connected to a second connecting object; and the housing having inserting holes for arranging and holding the contacts therein, and a fitting opening for receiving the first connecting object. The housing is provided on the side of the fitting opening with recesses which are continuous with the inserting holes, respectively, and opening into the fitting direction of the connector, and tips of the contact portions of the contacts are positioned in the recesses, respectively, even in the state that the first connecting object has not been fitted in the connector. The recesses are respectively independent from one another corresponding to the contacts. The connector thus constructed is simple in construction and easily manufactured and achieves a stable electrical connection by ensuring sufficient displacements of the contacts without buckling and deformation of the contacts, thereby preventing any defective or failed connection.

### BACKGROUND OF THE INVENTION

This invention relates to a connector for use with electric and electronic appliances such as industrial machines, automobiles, personal computers, and the like, and more particularly to a connector capable of ensuring sufficient displacements of contact portions of contacts even if the width of the connector is limited to 2.5 to 3 mm, and obtaining stable electrical connection without any deformation of the contacts.

Inherently, a connector is detachably fitted with a first connecting object, and is connected to a second connecting object. Therefore, the connector comprises at least a plurality of contacts each having a contact portion adapted to contact the first connecting object, a fixed portion to be fixed to a housing, and a connection portion to be connected to the second connecting object, and the housing having inserting holes for arranging and holding the contacts therein and a fitting opening for receiving the first connecting object.

As examples of prior art connectors, incorporated herein are Japanese Utility Model Application Opened No. H7-016,381 (Patent Literature 1) proposed by the applicant of the present case, Japanese Patent Application Opened No. 2004-087,361 (Patent Literature 2), and Japanese Patent Application Opened No. 2006-179,505 (Patent Literature 3).

Patent Literature 1

According to the abstract of the Japanese Utility Model Application Opened No. H7-016,381, this utility model has an object to provide an electrical connector having a reliable locking force even if the connector is miniaturized and its overall height is reduced, and enabling a point in time at which fitting has been completed to be easily recognized even if a fitting stroke is small. Disclosed is an electrical connector consisting of a male connector 50 and a female connector 30, the female connector 30 including contacts 40 each having an elasticity in its thickness direction and bifurcated into two branches, one branch 44 having an electric contact portion 45 and the other branch 46 having a recess 48, while the male connector 50 including contacts 60 each having a shape to be fitted in the inside of the bifurcated contact of the female connector, so that when these contacts are fitted with each other, the electric contact portions 45 of the female connector 30 and the contacts 60 of the male connector 50 are brought into electric contact with each other, and protrusions 68 are fitted in the recesses 48, respectively, to generate an audible click (metallic sound) to indicate that the fitting has been just completed, and at the same time the locking being securely actuated.

Incidentally, claim of the Japanese Utility Model Application Opened No. H7-016,381 recites an electrical connector in which when fitted, pairs of contacts slide on each other to be in electric contact with each other, wherein one contact of each pair of contacts is bifurcated and having plate shaped tips and an elasticity in thickness directions and the other contact has a shape adapted to be fitted in the inside of the bifurcated portion of the one contact, and wherein one branch of the each bifurcated contact has an electric contact portion on its inner side adapted to electrically contact the other contact, and between the other branch of the one bifurcated contact and the other contact there is provided a locking mechanism consisting of a protrusion and a recess into which the protrusion is fitted.

Patent Literature 2

According to the abstract of the Japanese Patent Application Opened No. 2004-087,361, this invention has an object to provide a connector for a flexible printed circuit board, which eliminates a risk of an actuator being dislodged during being actuated. This connector comprises an insulating housing 1, a plurality of terminals 2 and 3, and an actuator 4. The plurality of terminals 2 and 3 comprise the following parts for each one set of terminals. The terminal 3 has, for each one set of terminals, a pushing beam 35 formed with an engaging edge 351 extending toward a flexible printed circuit board inserting opening 13 and adapted to engage a cam portion 47 of the actuator 4. The terminal 2 has a first constraining edge 251 extending toward the flexible printed circuit board inserting opening 13 and a hook-shaped constraining beam 25 formed with a second constraining edge 252 continuous with and substantially perpendicular to the first constraining edge 251 and adapted to engage a pin portion 44 provided on the actuator 4. The actuator 4 is possible to change its behavior between a first position in which the circuit board can be inserted and a second position in which electrical connection is formed between contacts of the circuit board and contact pieces 23 and 33 of the terminals 2 and 3, and dislodgement of the actuator is prevented while changing its behaviors.

Incidentally, claim 1 of the Japanese Patent Application Opened No. 2004-087,361 recites a connector for a flexible printed circuit board, including an insulating housing (1) formed with a circuit board inserting opening (13) and a connection cavity (14) communicating with the circuit board inserting opening (13), a plurality of terminals (2 and 3) installed in said insulating housing (1) side by side and having respective contact pieces (23 and 33) party located in said connection cavity (14), pushing portions (48) for pushing the flexible printed circuit board (7) inserted in said connection cavity (14) toward the contact pieces (23 and 33) of the terminals (2 and 3), and an actuator (4) having cam portions (47) for moving the pushing portions (48), wherein said plurality of the terminals (2 and 3) consist of terminals (3) each having, for each one set of terminals, a pushing beam (35) formed with an engaging edge (351) extending from said terminal proximal end (3A) toward the flexible printed circuit board inserting opening (13) and adapted to engage the cam portion (47) of said actuator (4) and terminals (2) each having a first constraining edge (251) extending from said terminal proximal end (2A) toward the flexible printed circuit board inserting opening (13) and a hook-shaped constraining beam (25) formed with a second constraining edge (252) continuous with and substantially perpendicular to the first constraining edge (251) and adapted to engage a pin portion (44) provided on said actuator (4), and the actuator (4) is possible to change its behavior between a first position in which the circuit board (7) can be inserted and a second position in which electrical connection is formed between contacts of the circuit board (7) and the contact pieces (23 and 33) of the terminals (2 and 3), while the actuator (4) is prevented from being dislodged by cooperation of the pushing beams (35) with the constraining beams (25) during changing of the behavior of the actuator (4) between said first and second positions. Claim 2 recites the connector for a flexible printed circuit board as claimed in claim 1, wherein the cam portions (47) of said actuator (4) each have an engaging corner (471) adapted to engage the engaging edge (351) of said pushing beam (35) and an engaging plane (472) continuous with the engaging corner (471) so that when said actuator (4) is in the first position, the engaging corner (471) engages said engaging edge (351), while when said actuator (4) is in the second position, the engaging plane (472) engages said engaging edge (351). Claim 3 recites the connector for a flexible printed circuit board as claimed in claim 2, wherein the engaging corner (471) of said cam portion (47) is in a position different from and eccentric to the center of said pin portion (44). Claim 4 recites the connector for a flexible printed circuit board as claimed in claim 2 or 3, wherein the engaging edge (351) of said pushing beam (35) is formed with a recess (352) corresponding to the engaging corner (471) of said cam portion (47). Claim 5 recites the connector for a flexible printed circuit board as claimed in any one of claims 1 to 4, wherein the pin portions (44) of said actuator (4) move along the first constraining edges (251) and the second constraining edges (252) of the constraining beams (25) in response to the changing of the behavior of the actuator (4).

Patent Literature 3

According to the abstract of the Japanese Patent Application Opened No. 2006-179,505, this invention has an object to provide a connector for a flexible printed circuit board, which eliminates a risk of an actuator being dislodged during being actuated and gives an operator a click response when the behavior of the actuator is changed. This connector comprises an insulating housing 1, a plurality of terminals 2 and 3, and an actuator 4. The plurality of terminals 2 and 3 comprise the following parts for each one set of terminals. The terminal 3 has, for each one set of terminals, a pushing beam 35 formed with an engaging edge 351 extending toward a flexible printed circuit board inserting opening 13 and adapted to engage a cam portion 47 of the actuator 4. The terminal 2 has a first constraining edge 251 extending toward the flexible printed circuit board inserting opening 13 and a hook-shaped constraining beam 25 formed with a second constraining edge 252 continuous with and substantially perpendicular to the first constraining edge 251 and adapted to engage a pin portion 44 provided on the actuator 4. The actuator 4 is possible to change its behavior between a first position in which the circuit board can be inserted and a second position in which electrical connection is formed between contacts of the circuit board and contact pieces 23 and 33 of the terminals 2 and 3, and dislodgement of the actuator is prevented while changing its behaviors.

Incidentally, claim 1 of the Japanese Patent Application Opened No. 2006-179,505 recites a connector for a flexible printed circuit board, including an insulating housing (1) formed with a circuit board inserting opening (13) and a connection cavity (14) communicating with the circuit board inserting opening (13), a plurality of terminals (2 and 3) installed in said insulating housing (1) side by side and having respective contact pieces (23 and 33) partly located in said connection cavity (14), pushing portions (48) for pushing the flexible printed circuit board (7) inserted in said connection cavity (14) toward the contact pieces (23 and 33) of the terminals (2 and 3), and an actuator (4) having cam portions (47) for moving the pushing portions (48), wherein said plurality of the terminals (2 and 3) consist of terminals (3) each having, for each one set of terminals, a pushing beam (35) formed with an engaging edge (351) extending from its terminal proximal end (3A) toward the flexible printed circuit board inserting opening (13) and adapted to engage the cam portion (47) of said actuator (4) and terminals (2) each having a first constraining edge (251) extending from its terminal proximal end (2A) toward the flexible printed circuit board inserting opening (13) and a hook-shaped constraining beam (25) formed with a second constraining edge (252) continuous with and substantially perpendicular to the first constraining edge (251) and adapted to engage a pin portion (44) provided on said actuator (4), and the actuator (4) is possible to change its behavior between a first position in which the circuit board (7) can be inserted and a second position in which electrical connection is formed between contacts of the circuit board (7) and the contact pieces (23 and 33) of the terminals (2 and 3), and wherein when the actuator (4) is changed in its behavior from the first position to the second position, said pin portions (44) are constrained to move by said first constraining edges (251) and said second constrained edges (252), and said cam portions (47) are constrained to move by said pushing beams (35), and during the behavior change starting stage, the actuator (4) is varied in its tilting angle about engagement portion as a fulcrum between engaging corners (471) of the cam portions (47) and recesses (352) formed in said engaging edges (351), and the behavior change is being progressed in a manner that said pin portions (44) move to a position where the pin portions (44) engage said second constraining edges (252) and further, through a stage of disengagement of said engaging corners (471) from said recesses (352), engaging planes (472) of the cam portions (47) become progressively parallel to said engaging edges (351). Claim 2 recites the connector for a flexible printed circuit board as claimed in claim 1, wherein the actuator is changed in its tilting angle at a position as a fulcrum where the engaging corners (471) of said cam portions (47) are remote from the center positions of said pin portions (44). Claim 3 recites the connector for a flexible printed circuit board as claimed in claim 1, wherein in said second position, the linear engaging edges (351) of said pushing beams (35) engage said engaging planes (472). Claim 4 recites the connector for a flexible printed circuit board as claimed in claim 1, wherein when the actuator (4) is changed in its behavior from the first position to the second position, dowels (401) provided on both ends of the actuator (4) protrude into longitudinal grooves (171) formed at intermediate positions in side walls (17) of the insulating housing (1), and limiting projections (402) provided at both ends of the actuator (4) engage R-shaped outer peripheries (172R) of engaging portions (172) formed on said side walls (17) and further ride over the R-shaped outer peripheries (172R).

With a connector having a fitting opening into which a first connecting object is inserted, in general, tips of contacts frequently protrude into the fitting opening as disclosed in the Patent Literature 1. When the tips of the contacts protrude into the fitting opening, however, there would be a tendency for the contacts to be buckled or deformed upon inserting the first connecting object.

In order to prevent the contacts from being buckled or deformed, the contacts must be so arranged that the tips of the contacts do not abut against the first connecting object and are not exposed into the fitting opening. In order to achieve the electrical connection with the first connecting object, however, at least the contact portion of the contacts must necessarily be exposed into the fitting opening.

In recent years, moreover, with the miniaturization of electric and electronic appliances, the requirement for miniaturization of connectors has been increased. With the miniaturization of connectors, it has been necessary to ensure sufficient displacements of contacts for connection stability other than the prevention of buckling and deformation of the contacts.

In order to obtain sufficient displacements of contacts for stable electrical connection, one solution is to provide holes in an insulating housing at positions corresponding to tips of the contacts as shown in FIGS. 1 to 3 of the Patent Literatures 2 and 3. With the constructions disclosed in the Patent Literatures 2 and 3, a first connecting object cannot be sufficiently conducted to contact portions of contacts because the countermeasure is to provide the holes. Owing to a metal die structure for molding the housing, burrs or molding fins would be likely to occur at matching surfaces of metal dies for injection molding of the housing. With the miniaturization of connector (extremely narrow pitches of conductors and miniaturization in width directions), wall thicknesses of the housing become thinner so that injection molding of the housing would become difficult. Moreover, wobbling or tilting of contacts in directions of rows of the contacts could not be prevented, sometimes resulting in defective or failed connection.

### SUMMARY OF THE INVENTION

In view of the problems with the prior art described above, the invention has been completed, and it is an object of the invention to provide a connector which is easily manufactured because of its simple construction and achieves stable connection by ensuring sufficient displacements of contacts without any buckling and deformation of contacts, thereby precluding any defective or failed connection.

The object can be achieved by the connector 10 detachably fitted with a first connecting object (not shown) and adapted to be connected to a second connecting object (not shown), including a plurality of contacts 14 each having a contact portion 22 adapted to contact said first connecting object, a fixed portion 24 to be fixed to a housing 12, and a connection portion 26 to be connected to said second connecting object; and the housing 12 having inserting holes 18 for arranging and holding said contacts 14 therein and a fitting opening 16 for receiving said first connecting object, constructed according to the invention in that said housing 12 is provided on the side of said fitting opening 16 with recesses 20 which are continuous with said inserting holes 18, respectively, and opening into the fitting direction of the connector 10, and tips 28 of the contact portions 22 of said contacts 14 are positioned in said recesses 20, respectively, even in the state that said first connecting object has not been fitted in the connector 10, and that said recesses 20 are independent from one another corresponding to said respective contacts 14.

The invention claimed in claim 2 lies in the connector 10 constructed in that said contacts 14 are each provided with a conducting portion 30 in the proximity of said contact portion 22, and that said housing is provided in each of recesses 20 with a relief portion 32 for said conducting portion 30 of the contact 14 and further provided with guides 38 on both sides in width directions of each of said recesses for guiding said first connecting object.

The invention claimed in claim 3 lies in the connector 10 constructed in that depth of said recesses 20 is 0.3 to 0.8 mm, while displacements of the contact portions 22 of said contacts 14 are 0.2 to 0.5 mm.

As can be seen from the explanation described above, the connector according to the invention can bring about the following significant functions and effects.

(1) A connector 10 claimed in claim 1 is detachably fitted with a first connecting object and adapted to be connected to a second connecting object, including a plurality of contacts 14 each having a contact portion 22 adapted to contact said first connecting object, a fixed portion 24 to be fixed to a housing 12, and a connection portion 26 to be connected to said second connecting object; and the housing 12 having inserting holes 18 for arranging and holding said contacts 14 therein and a fitting opening 16 for receiving said first connecting object, wherein said housing 12 is provided on the side of said fitting opening 16 with recesses 20 which are continuous with said inserting holes 18, respectively, and opening into the fitting direction of the connector 10, and tips 28 of the contact portions 22 of said contacts 14 are positioned in said recesses 20, respectively, even in the state that said first connecting object has not been fitted in the connector 10, and wherein said recesses 20 are independent from one another corresponding to said respective contacts 14. Therefore, the connector according to the invention is easily manufactured because of its simple construction. Moreover, the connector according to the invention achieves stable connection by ensuring sufficient displacements of the contacts without any buckling and deformation of the contacts, thereby completely avoiding defective or failed connection.

(2) The connector 10 as claimed in claim 2 is constructed in that said contacts 14 are each provided with a conducting portion 30 in the proximity of said contact portion 22, and that said housing is provided in each of recesses 20 with a relief portion 32 for said conducting portion 30 of the contact 14 and further provided with guides 38 on both sides in width directions of each of said recesses for guiding said first connecting object. Accordingly, the connector according to the invention is easily manufactured because of its simple construction and enables a mating connecting object to be easily conducted into the connector. Further, the connector according to the invention achieves stable connection by ensuring sufficient displacements of the contacts without any buckling and deformation of the contacts, thereby completely avoiding defective or failed connection.

(3) The connector 10 as claimed in claim 1, constructed in that depth of said recesses 20 is 0.3 to 0.8 mm, while displacements of the contact portions 22 of said contacts 14 are 0.2 to 0.5 mm. Consequently, the connector according to the invention is easily manufactured because of its simple construction. Moreover, the connector according to the invention achieves stable connection by ensuring sufficient displacements of the contacts without any buckling and deformation of the contacts, thereby completely avoiding defective or failed connection.

The invention will be more fully understood by referring to the following detailed specification and claims taken in connection with the appended drawings.

### BRIEF DESCRIPTION OF THE DRAWINGS

FIG. 1A is a perspective view of a connector according to the invention viewed from its fitting side;

FIG. 1B is a perspective view of the connector according to the invention viewed from its connection side;

FIG. 2 is a perspective view of a contact used in the connector according to the invention;

FIG. 3A is a perspective view of a housing of the connector according to the invention viewed from its fitting side;

FIG. 3B is a perspective view of the housing viewed from its connection side; and

FIG. 4 is a sectional view of the connector according to the invention taken along one contact.

### DESCRIPTION OF THE PREFERRED EMBODIMENTS

The subject feature of the invention lies in the connector 10 detachably fitted with a first connecting object and adapted to be connected to a second connecting object, including a plurality of contacts 14 each having a contact portion 22 adapted to contact said first connecting object, a fixed portion 24 to be fixed to a housing 12, and a connection portion 26 to be connected to said second connecting object; and the housing 12 having inserting holes 18 for arranging and holding said contacts 14 therein and a fitting opening 16 for receiving said first connecting object. Further, the housing 12 is provided on the side of said fitting opening 16 with recesses 20 which are continuous with said inserting holes 18 and opening into the fitting direction of the connector, and tips 28 of the contact portions 22 of said contacts 14 are positioned in said recesses 20 even in the state that said first connecting object has not been fitted in the connector 10, and further said recesses 20 are separately independent from one another corresponding to said respective contacts 14.

Namely, the housing 12 is provided with recesses 20 opening into the fitting direction of the connector and independent from one another corresponding to the contacts 14, respectively. The tips 28 of the contact portions 22 of the contacts 14 are received in the recesses 20. With such a simple construction, stable connection (contact) can be obtained by ensuring sufficient displacements of the contacts 14 without any buckling and deformation of the contacts 14.

Before explaining the connector 10 of the embodiment of the invention, a first connecting object and a second connecting object will be explained. The first connecting object includes a mating connector, flexible printed circuit board, substrate, and the like. The first connecting object in the illustrated embodiment is a mating connector.

The second connecting object includes a flexible printed circuit board, substrate, and the like. The second connecting object in the illustrated embodiment is a substrate.

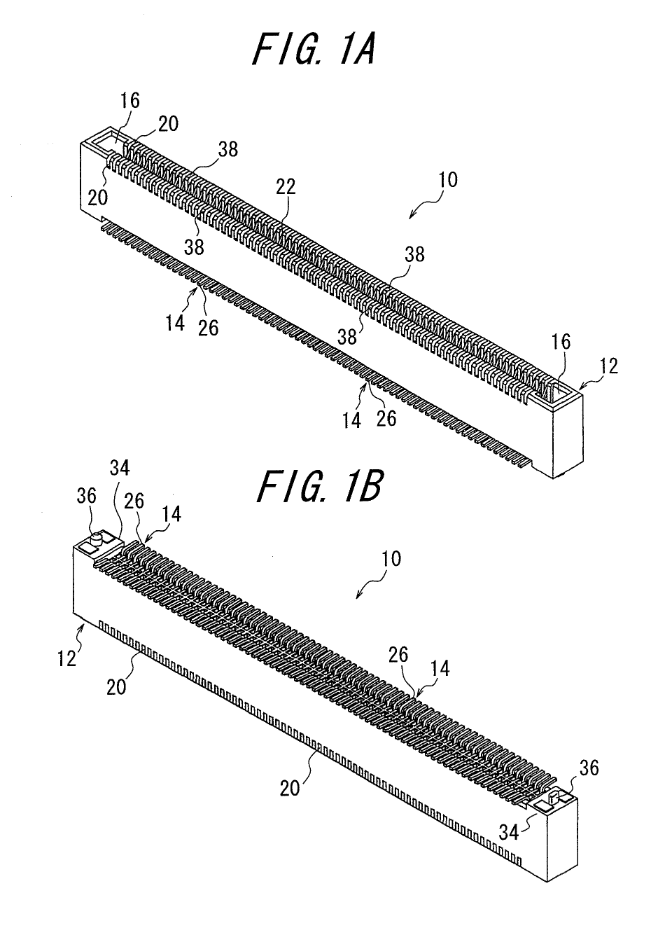

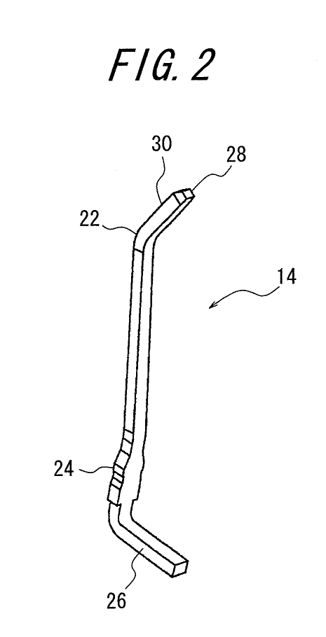

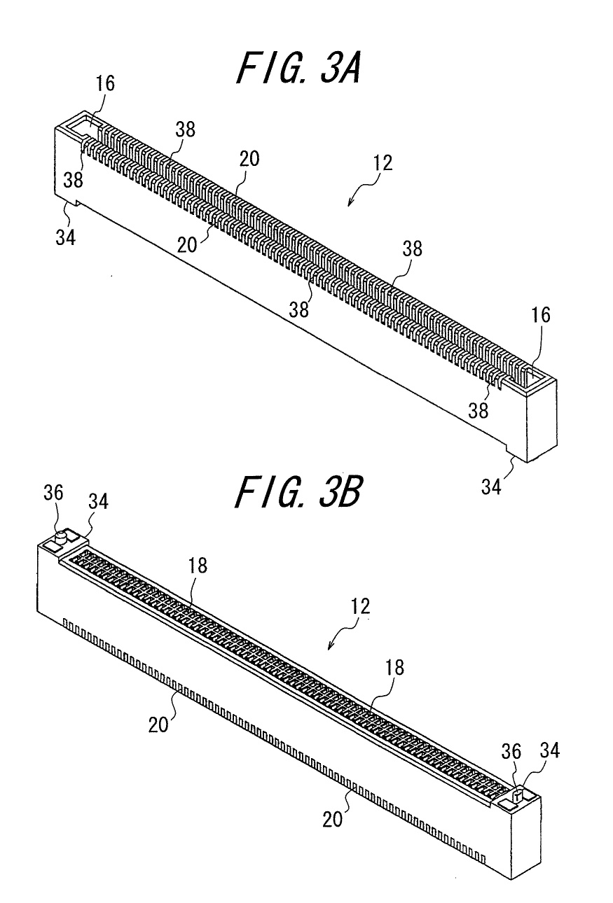

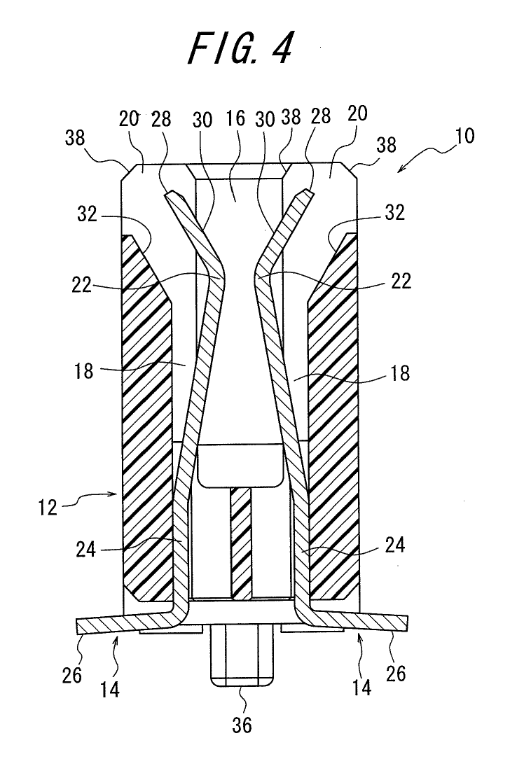

The connector according to the embodiment of the invention will be explained with reference to the drawings. FIG. 1A is a perspective view of the connector viewed from its fitting side, and FIG. 1B is a perspective view of the connector viewed from its connection side. FIG. 2 is a perspective view of a contact. FIG. 3A is a perspective view of a housing viewed from the fitting side, while FIG. 3B is a perspective view of the housing viewed from the connection side. FIG. 4 is a sectional view of the connector taken along one contact.

The connector 10 according to the invention comprises a housing 12 as an insulator, and a plurality of contacts 14.

At the beginning, the housing 12 will be explained. The housing 12 is formed from an electrically insulating plastic material by means of the injection molding of the known technique. The materials for the housing 12 may be suitably selected in consideration of dimensional stability, workability, manufacturing cost, and the like and generally include polybutylene terephthalate (PBT), polyamide (66PA or 46PA), liquid crystal polymer (LCP), polycarbonate (PC), polyphenylene sulfide (PPS), and the like and combination thereof. The housing 12 is provided with inserting holes 18 into which a required number of the contacts are installed, respectively, which are fixed thereinto by press-fitting, hooking (lancing), welding, or the like. They are press-fitted in the inserting holes 18 of the housing 12 in the illustrated embodiment.

The housing 12 has a fitting opening 16 for receiving the mating connector. The fitting opening 16 only needs to receive the mating connector as the first connecting object and to obtain a stable connection with the mating connector. The shape and the size of the fitting opening 16 may be suitably designed in consideration of connection stability, shape and size of the mating connector, and the like.

Said housing 12 is formed with recesses 20 opening into the fitting direction of the connector and arranged separately and independently from one another. The number of the recesses 20 corresponds to the number of the contacts 14. The recesses 20 are arranged so as to be continuous with said fitting opening 16 and said inserting holes 18, respectively, and serve to protect tips 28 of said contacts 14 from being buckled and deformed to ensure displacements of the contacts 14, and to guide contacts of the mating connector and simultaneously to prevent said contacts 14 from wobbling or tilting in directions of rows of the contacts. The size of said recesses 20 may be suitably designed taking into account such functions. Depth (seen from the paper level) of the recesses 20 is 0.3 to 0.8 mm and the vertical length (in the inserting direction of the mating connector) of the recesses 20 is 0.2 to 0.5 mm in the illustrated embodiment.

Said housing 12 is provided with relief portions 32 in the recesses 20, respectively, for accommodating displacements of conducting portions 30 of said contacts 14 (refer to FIG. 4). The size and shape of said relief portions 32 need only allow the displacements of the contacts 14 upon inserting the mating connector into the housing 12, and may be suitably designed in consideration of such functions, strength of said housing 12, and the like. Moreover, the housing 12 is further provided with guides on both sides in with directions of each of said recesses for guiding the first connecting object.

Moreover, said housing 12 is provided at longitudinal ends with positioning protrusions 36 on flanges 34 for positioning the connector 12 relative to a substrate. The size and shape of said positioning protrusions 36 need only be able to accurately position the connector 10 relative to the substrate, and may be suitably designed in consideration of workability, positioning ability, strength, and the like. In the illustrated embodiment, one positioning protrusion is circular, while the other is elliptical in order to prevent the connector from being erroneously positioned relative to the substrate.

The contacts 14 will be finally explained. Said contacts 14 are made of a metal and formed by means of the press-working of the known technique. Preferred metals from which to form said contacts 14 include brass, beryllium copper, phosphor bronze and the like which comply with the requirements as to springiness, electric conductivity, and the like. The contacts 14 each comprise mainly a contact portion 22 adapted to contact the first connecting object (a mating connector in the illustrated embodiment), a fixed portion 24 to be fixed to said housing 12, and a connection portion 26 to be connected to the second connecting object (the substrate in the illustrated embodiment).

The respective parts of the contact 14 are arranged in the order of the contact portion 22, the fixed portion 24, and the connection portion 26 from the side nearer to the fitting opening 16 of the housing 12. The respective parts will be explained hereafter. First, said contact portion 22 is adapted to contact the mating connector and is substantially in the form of a curved shape so that the contact portion 22 is at one location in line contact with one contact of the mating connector. The contact portion 22 only needs to contact the mating contact, and may be suitably designed taking into account the contact stability, space saving of the connector 10 upon being fitted, a reduced overall height of the connector 10, workability, and the like.

Said fixed portion 24 is held in the inserting hole 18 of said housing 12 and is held in the inserting hole 18 by means of press-fitting in the illustrated embodiment. Any methods other than the press-fitting may be used for this purpose insofar as the contacts can be securely held in the housing, and the holding method may be suitably selected in consideration of a miniaturization of the connector, strength, holding force, and the like.

Said connection portion 26 is to be connected to a substrate and may be of any shape (type) so long as it can be connected to the substrate. The connection portions 26 of the contacts 14 in the illustrated embodiment are of a surface mounting type (SMT). For example, a dip type may be employed. Moreover, the connection portions 26 are arranged so as not to protrude from said housing 12 for the purpose of contributing to the space-saving.

The contacts 14 are arranged in the inserting holes 18 of the housing 12 such that the tips 28 of the contact portions 22 of the contacts 14 are positioned in the recesses 20 of the housing 12, respectively, with the result that the contacts 14 are securely prevented from wobbling or tilting in the directions of the rows of the contacts.

Moreover, the recesses 20 of the housing 12 and the contact portions 22 of the contacts 14 are so related that the depth of the recesses 20 is 0.3 to 0.8 mm and the displacements of the contact portions 22 of the contacts 14 are 0.2 to 0.5 mm.

Examples of applications of the present invention are connectors for use with electric and electronic appliances such as industrial machines, automobiles, personal computers, and the like, and the more particularly, connectors capable of ensuring sufficient displacements of contact portions of contacts even if the width of the connector is limited to 2.5 to 3 mm, and obtaining stable electrical connection without any deformation of the contacts.

While the invention has been particularly shown and described with reference to the preferred embodiments thereof, it will be understood by those skilled in the art that the foregoing and other changes in form and details can be made therein without departing from the spirit and scope of the invention.

What is claimed is:

1. A connector detachably fitted with a first connecting object and adapted to be connected to a second connecting object,
including a plurality of contacts each having a contact portion adapted to contact said first connecting object, a fixed portion to be fixed to a housing, and a connection portion to be connected to said second connecting object; and the housing having inserting holes for arranging and holding said contacts therein and a fitting opening for receiving said first connecting object,
wherein said housing is provided on the side of said fitting opening with recesses which are continuous with said inserting holes, respectively, and opening into the fitting direction of the connector,
tips of the contact portions of said contacts are positioned in said recesses, respectively, even in the state that said first connecting object has not been fitted in the connector, and
said recesses are independent from one another corresponding to said respective contacts.

2. The connector as claimed in claim 1, wherein said contacts are each provided with a conducting portion in the proximity of said contact portion, and wherein said housing is provided in each of said recesses with a relief portion for said conducting portion of said contact to allow to escape therein and further provided with guides on both sides in width directions of each of said recesses for guiding said first connecting object.

3. The connector as claimed in claim 1, wherein depth of said recesses is 0.3 to 0.8 mm, while displacements of the contact portions of said contacts are 0.2 to 0.5 mm.
